(19) United States
(12) Patent Application Publication
(10) Pub. No.: US 2013/0292339 A1
(43) Pub. Date: Nov. 7, 2013

(54) METHOD AND APPARATUS FOR SEPARATION OF OIL AND WATER USING HYDROPHOBIC AND HYDROPHILIC FUNCTIONAL SOLID PARTICLES

(71) Applicants: Werner Hartmann, Weisendorf (DE); Andreas Hauser, Singapore (SG)

(72) Inventors: Werner Hartmann, Weisendorf (DE); Andreas Hauser, Singapore (SG)

(73) Assignee: SIEMENS AKTIENGESELLSCHAFT, Munich (DE)

(21) Appl. No.: 13/997,049

(22) PCT Filed: Dec. 1, 2011
(86) PCT No.: PCT/EP2011/071496

§ 371 Date: Jun. 21, 2013

(30) Foreign Application Priority Data
Dec. 23, 2010 (DE) 10 2010 064 139.1

(51) Int. Cl. B01D 17/04

(52) U.S. Cl. CPC B01D 17/047
USPC 210/695; 210/708; 210/222; 210/223

(57) ABSTRACT

An oil/water emulsion is mixed with functional solid particles to agglomerate oil droplets and/or water droplets having functional solid particles and the functional solid particles are hydrophobicized for the agglomeration of oil droplets or are hydrophilicized for the agglomeration of water droplets. This enables oil and water to be separated from an oil/water emulsion under gravitational forces.

### CROSS REFERENCE TO RELATED APPLICATIONS

This application is the U.S. national stage of International Application No. PCT/EP2011/071496, filed Dec. 1, 2011 and claims the benefit thereof. The International Application claims the benefit of German Application No. 102010064139.1 filed on Dec. 23, 2010, both applications are incorporated by reference herein in their entirety.

### BACKGROUND

Described below is a treatment of a mixture of oil and water, in particular crude oil and water, which is essentially present as an oil/water emulsion. The main approach involves separating off the water from the oil

Apart from a certain solids content, the oil/water emulsion is typically formed of 10-30 pm sized droplets with a water content of typically 10-30%. Because of the small size of the droplets, they are held in suspension by Brownian motion. For this reason, the emulsion constituents oil and water cannot be separated using simple sedimentation and flotation methods.

Similar applies to the removal of dissolved mineral substances present in the oil, particularly sulfides and chlorides. For basic separation of these substances from the oil, the pre-treated crude oil is mixed once again with water to form an emulsion. The soluble mineral components typically migrate to the water phase and are therefore removed from the oil. Also at this stage of the process the emulsion present is again separated into separate flows of water and oil respectively.

In the related art, electrostatic agglomerators are used to separate oil and water from an emulsion, wherein the emulsion present is subjected to a DC or AC field or a combination of the two, voltages of 20 to 30 kV being applied. The droplets possibly separated from one another by several 10 μm are caused to vibrate so that they intermittently come into contact, causing them to merge into larger drops. The energy requirement of such a system is very high. This is due to the high conductivity of the emulsion because of the salts dissolved in the water and in the oil and the therefore enormously high ohmic losses.

If the droplet size is sufficiently large, the oil droplets have sufficient upward buoyant force or the water droplets have sufficient downward force to initiate phase separation between oil and water due to gravitational forces. However, once the process is sufficiently advanced, the distance between the remaining droplets in the emulsion will increase so that further drop enlargement can no longer be achieved. The small droplets then still remaining in the emulsion can therefore no longer be separated off, so that some of the oil is lost in the water or some of the water remains in the oil.

### SUMMARY

Described below are a method and an apparatus allowing improved and faster separation of the oil from the water, or vice versa, with low energy input.

The method is based on the insight that, for the treatment of an oil/water emulsion, in order to agglomerate oil droplets or water droplets to form larger drops of either oil or water, mixing of functional solid particles with the emulsion is performed, wherein the functional solid particles are either hydrophobized for the agglomeration of oil droplets and/or hydrophilized for the agglomeration of water droplets. Processes involving high electrical power consumption are not initially used.

The functional solid particles are generally surface treated so that they have either a hydrophobic or a hydrophilic surface effect. The formation of larger drops, either of oil or water, necessary for phase separation between oil and water is not produced as in the related art by droplet vibration wherein the droplets come into contact, but by attachment of the functional solid particles either only to the oil droplets and not to the water droplets, or only to the water droplets and not to the oil droplets.

For the solid particles, magnetizable materials are used, e.g. natural or artificially produced magnetite, having grain sizes typically in the region of the initial droplet sizes. By placing a resulting suspension of functional solid particles and either attached oil drops or attached water drops in a magnetic field, the particles surrounded by an oil or water film, as the case may be, combine to form larger agglomerates, thereby expelling either the water or the oil. Either a pure oil/solids suspension and a pure water phase or a pure water/solids suspension and an oil phase are produced.

A variant of mixing with hydrophilic functional solid particles operates similarly to the first variant in that the suspension of solid matter and water and the oil phase can be separated off in pure form. The advantage of this is that the separation of functional solid particles can take place in a liquid having low viscosity.

In another variant, hydrophobic and hydrophilic solid particles are introduced simultaneously, so that both a magnetizable oil-rich suspension and a magnetizable water-rich suspension are formed which have sharp phase boundaries and are separated from one another in separate magnet arrangements.

For the case that the functional solid particles are non-magnetic or only weakly magnetic, so that they differ from one another only in respect of hydrophobicity/hydrophilicity in order to have an affinity for the oil and water respectively, a gravity method can be used to produce the pure phase in each case. This is used for the respective agglomeration of either oil droplets or water droplets and to form corresponding agglomerates.

If functional solid particles are added to an oil/water emulsion, separation between oil and water can be achieved by the method, wherein the water holds additional substances in solution. The essential advantage of this is that complex/costly downstream purifying processes can be made much simpler and less expensive.

### DETAILED DESCRIPTION OF THE PREFERRED EMBODIMENT

Detailed exemplary embodiments will now be described which do not limit the scope of the invention but merely represent advantageous embodiments.

The core aspect of the method is that it obviates the need for energy-intensive agglomeration in an electric or magnetic field, constant or alternating field. In contrast thereto, the method utilizes the fact that functional solid particles can be admixed to an emulsion in order to achieve selective agglomeration, e.g. of oil or of water in an oil/water emulsion.

Magnetizable particles such as magnetite (Fe₃O₄) or non-magnetizable particles such as sand (SiO₂) can be used as suitable materials for the functional solid particles. The method utilizes the fact that these particles, which are surface treated accordingly in order to have a desired functionality, selectively attach themselves to the oil droplets or to the water droplets, but do not combine with the respective other kind of droplets.

If the resulting suspension, which represents a suspension of solids in a liquid, is placed in a magnetic field, the magnetic particles coated with an oil film combine, if they are hydrophobic, to form larger agglomerates, causing the water to be expelled and enabling it to be separated off. The largely pure oil/magnetite suspension as such produced as a result of the high density of the magnetite settles below the water. The functional solid particle component, in particular magnetite, is separated from the oil in a magnetic separator. In particular, a magnetic separator having a magnetically generated moving field is used here. However, other magnetic separators according to the prior art can also be used, e.g. magnetic drum separators, belt separators, or high-field or high-gradient separators having normally or superconducting field windings.

It is particularly advantageous if the functional solid particles are non-magnetic or only weakly magnetic and agglomerate water droplets to larger drops and to a water phase. The differentiation is essentially between a hydrophobic or hydrophilic surface in order, on the one hand, to combine oil droplets to form larger drops or, on the other hand, to bind them.

For the case that the functional solid particles are non-magnetic or only weakly magnetic, a gravity method is used to produce a pure phase, of either water or oil. The aim is to densify the respective agglomerates to the extent that the pure phases are enlarged by contact and combination of the individual droplets to form drops and therefore constitute the agglomerates. Suitable processes occur, for example, in hydrocylones and in continuously operating ultracentrifuges, as in a decanter/tricanter or in comparable arrangements.

The functional solid particles introduced into the separation process cause agglomeration to proceed without DC or AC fields. On the other hand, foreign bodies which are expediently reclaimed in a suitable recycling process, i.e. are basically scrubbed, are also introduced into the process by the solid particles. In a specific case, magnetite particles are recycled in this way and returned to the process. In some cases, oil residues remaining on the particles must be removed by suitable techniques such as thermal vaporization or by chemical means in order to be able to re-use the magnetite particles.

For example, if hydrophilized magnetite particles are used, and if the water phase is separated from the oil similarly to the method described, the resulting advantage is that separation of the magnetic particles can take place in a less viscous liquid such as water instead of oil. In general, both water and the magnetic particles have a higher density than the oil to be separated off, so that also in this case a clear separation is produced between a lower water/magnetite suspension and a purified oil layer above it.

As larger volume units of the functional solid particles are to be used, a suitable solid having appropriate properties must be found. Magnetite, for example, also known as magnetic iron ore, is particularly suitable. This is mineral from the oxide class of minerals and constitutes the most stable compound of iron and oxygen. Because of the high iron content of up to about 70%, magnetite is one of the most important iron ores and raw materials for the electrical industry. Another suitable material is sand (SiO₂, silicon dioxide), for example. This is advantageous, as sand is available in sufficient quantities at low prices. Solid particles having appropriate grain sizes can be produced. Surface treatment for hydrophobization or hydrophilization is possible.

A significant advantage is that, assuming a thorough mixing of the emulsion with functional solid particles, the essential constituents of the emulsion can be separated even if the emulation is already strongly diluted. Relatively pure material flows, of either oil or water, can therefore be achieved. This obviates the need for complex/costly downstream cleaning processes which can be made much simpler and less expensive. In particular, not only energy-efficient agglomeration but also more effective separation within the overall process can be achieved.

All kinds of particles in the nanometer or micrometer range can generally be coated using suitable technologies. In particular, additional chemical or physical functions can be imparted.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-16. (canceled)

17. A method for separating oil and water from an oil/water emulsion by agglomerating oil droplets and/or water droplets to form larger drops in each case, and by phase separation between oil and water under gravitational forces, comprising:
mixing the oil/water emulsion with functional solid particles; and
agglomerating at least one of the oil droplets and the water droplets by at least one of hydrophobization of the functional solid particles for agglomeration of the oil droplets and hydrophilization of the functional solid particles for the agglomeration of water droplets.

18. The method as claimed in claim 17, wherein the functional solid particles are at least one of magnetic and magnetizable.

19. The method as claimed in claim 18, wherein the functional solid particles are formed of at least one material selected from the group consisting of magnetite and silicon dioxide.

20. The method as claimed in claim 19, wherein said mixing introduces both hydrophobic and hydrophilic functional solid particles simultaneously, producing both a magnetizable oil-rich suspension and a magnetizable water-rich suspension with sharp phase boundaries between them.

21. The method as claimed in claim 20, wherein said mixing of the oil/water emulsion with the functional solid particles increases phase separation of agglomerates of at least one of the oil droplets and the water droplets.

22. The method as claimed in claim 21, further comprising placing a suspension consisting of an oil/magnetite phase or a water/magnetite phase, resulting from at least one precipitation, in a magnetic field, thereby increasing the phase separation.

23. The method as claimed in claim 24, further comprising separating off a water component after phase separation, simultaneously removing mineral substances dissolved in the water.

24. The method as claimed in claim 23, wherein the mineral substances are included in the group consisting of sulfides and chlorides.

25. The method as claimed in claim 24, further comprising densifying an agglomerate of at least one of the oil and the water by a gravity method.

26. The method as claimed in claim 22, further comprising separating at least one of the oil and the water from the suspension and then separating the functional solid particles from the at least one of the oil and the water.

27. The method as claimed in claim 26, wherein said separating of the functional solid particles uses a magnetic separator.

28. The method as claimed in claim 26, further comprising recycling the functional solid particles after said separating of the functional solid particles.

29. The method as claimed in claim 17,
wherein the functional solid particles are at least one of non-magnetic particles and substantially weak magnetic particles, and
wherein said method further comprises producing pure phases using a gravity method to densify respective agglomerates by the pure phases combining through contact of at least one of the oil droplets and the water droplets to produce larger agglomerates.

30. An apparatus for separating oil and/or water from an oil/water emulsion, comprising at least one magnetic separator having a moving magnetic field.

31. The apparatus as claimed in claim 30, wherein the moving magnetic field of the at least one magnetic separator is electromagnetically generated.

32. The apparatus as claimed in claim 31, wherein the at least one magnetic separator includes at least one of a magnetic drum separator, a belt separator, a high-field separator and a high-gradient separator.
